(19) United States
(12) Patent Application Publication
(10) Pub. No.: US 2025/0354018 A1
(43) Pub. Date: Nov. 20, 2025

(54) SUPERHYDROPHOBIC MULTIFUNCTIONAL COATING AND PREPARATION METHOD THEREOF

(71) Applicants: Taizhou University, Taizhou (CN); Wenling Research Institute of Taizhou University, Taizhou (CN)

(72) Inventors: Vladimir Levchenko, Taizhou (CN); Changhong Lin, Taizhou (CN); Jianbo Wu, Taizhou (CN); Puyou Ying, Taizhou (CN); Ping Zhang, Taizhou (CN); Tao Yang, Taizhou (CN)

(21) Appl. No.: 18/736,494

(22) Filed: Jun. 6, 2024

(30) Foreign Application Priority Data
May 20, 2024 (CN) 202410626425.7

(51) Int. Cl. C09D 5/16; C09D 7/40; C09D 7/61; C09D 7/63; C09D 183/04

(52) U.S. Cl. CPC C09D 5/1675; C09D 5/1625; C09D 7/61; C09D 7/63; C09D 7/67; C09D 183/04

(57) ABSTRACT

A superhydrophobic multifunctional coating and a preparation method thereof are provided, which relate to the technical field of coating materials. The superhydrophobic multifunctional coating includes the following components in percentage by volume: 0.1-3.0% of hydrophobic composition, 1.5-12% of texture stabilizer, 17-60% of binder and 25-80% of alcohol-free substrate material. The multifunctional coating not only has the characteristics of high hydrophobicity, high wettability angle greater than or equal to 160+5 degrees, rolling angle less than or equal to 5 degrees, oleophobic property, chemical erosion medium resistance, chemical inertia, low surface tension and the like, but also does not need to pretreat materials, so that the surface physical and chemical characteristics of various materials can be improved.

### CROSS-REFERENCE TO RELATED APPLICATION

This application claims priority to Chinese patent application No. CN202410626425.7, filed to China National Intellectual Property Administration (CNIPA) on May 20, 2024, which is herein incorporated by reference in its entirety.

### TECHNICAL FIELD

The disclosure relates to the technical field of coating materials, and more particularly to a superhydrophobic multifunctional coating and a preparation method thereof.

### BACKGROUND

Patent RU2601339C2 reports a method for preparing a superhydrophobic coating with a water-containing solvent. The disadvantage of this method is that water is used as a substrate material. In addition, its main hydrophobic components are mainly composed of water-dispersible fluorine-containing and perfluorinated polymers and hydrophilic nanoparticles. Moreover, its superhydrophobic composition is cumbersome to prepare and complex in composition.

There is a known method to improve coating performance by using fluorine-containing silane (U.S. Pat. No. 6,737,105B2, RU2149151C1, and U.S. Pat. No. 7,425,279B2). The disadvantage of this method is that the water contact angle (also referred to as wettability angle) is small) (90-104° when the coating thickness is 10 nanometers (nm).

There is a known method for preparing a hydrophobic coating by using perfluoropolyether-modified silane (alkoxysilane) (U.S. Pat. Nos. 7,196,212 and B2 7,413,807B2). The disadvantage of this method is that although the coating thickness is in a range of 0.1-10 nm, the water contact angle can reach 114-117°. However, the coating did not improve hydrophobicity.

There is known a method for producing a superhydrophobic coating on surfaces containing hydroxyl groups and other functional groups by using fluorine-containing compounds. If fluorine-containing compounds are not used, the surfaces need to be pretreated by plasma. The surface treatment is divided into two stages: first, chlorosilane treatment, and then fluorinated silane treatment (EP0497189A2). The disadvantages of this method are the use of corrosive compounds and the need for complicated high-temperature surface treatment. The requirements for surface properties of original materials are high. Similar to the treatment process and results introduced in the patent EP0497189A2, the patent RU2400510C1 also reports a method of preparing a superhydrophobic coating, which uses fluorocarbon silane as a hydrophobic component and fumed silicon dioxide (also referred to as aerosil) as texture component. One disadvantage of this method is that alcohol and other organic solvents are used as the substrate material of hydrophobic composition, which may have serious adverse effects on the treated surface and narrow the application field. In addition, the coating lacks oleophobicity (also referred to as oleophobic property), so that the rolling angle is not small enough to realize the “self-cleaning” process. Therefore, the superhydrophobic coating has a short service life, insufficient oxidation resistance, chemical erosion medium resistance and corrosion resistance, and the coating is only suitable for small-scale production.

### SUMMARY

Aiming at the disadvantages of the related art, the disclosure provides a superhydrophobic multifunctional coating and a preparation method thereof. Specifically, a multifunctional superhydrophobic coating which does not need surface pretreatment is provided, the multifunctional superhydrophobic coating can be applied to different substrates, and has oleophobic property, low rolling angle, self-cleaning ability, non-corrosiveness, long-acting superhydrophobic and oleophobic effect, and resistance to chemical medium erosion and oxidation.

In order to achieve the above objectives, the disclosure is realized by the following technical solutions as follows.

The disclosure discloses a superhydrophobic multifunctional coating, which includes the following components in percentage by volume: 0.1-3.0% of hydrophobic composition, 1.5-12% of texture stabilizer, 17-60% of binder, and 25-80% of alcohol-free substrate material.

In an embodiment, the hydrophobic composition includes fluorocarbon silane with a molecular formula of CₓH_{y}F₁₃O₃Si, where x is an integer in a range of 10-15 and y is an integer in a range of 12-20.

In an embodiment, the hydrophobic composition further includes polymethylsiloxane with a viscosity in a range of 200-1000 centistokes (cst).

In an embodiment, the texture stabilizer is silicon dioxide, a specific surface area of the silicon dioxide is in a range of 70-320 square meters per gram (m²/g), and an average particle size is less than or equal to 5 nanometers (nm).

In an embodiment, the binder is polysiloxane, where a mass fraction of silicon dioxide is in a range 25-50 weight percent (wt %) and a mass fraction of tetraethoxysilane is in a range of 10-70 wt %.

In an embodiment, the alcohol-free substrate material is polymethylcyclosiloxane, and the polymethylcyclosiloxane is Dx, and x is an integer in a range of 4-5.

Correspondingly, a preparation method of the superhydrophobic multifunctional coating includes the following steps: uniformly stirring and mixing the hydrophobic composition, the texture stabilizer, the binder and the alcohol-free substrate material to synthesize a superhydrophobic coating solution.

In an embodiment, the preparation method further includes the steps: immersing a substrate in the superhydrophobic coating solution to soak the substrate for 1-36 hours to obtain soaked substrate, then taking out the soaked substrate, and purging and drying the soaked substrate at a temperature in a range of 17-100 Celsius degree (° C.) and an air flow rate in a range of 10-40 liters per second (L/s), so as to obtain the multifunctional superhydrophobic coating.

The disclosure has the following beneficial effects.

The superhydrophobic multifunctional coating provided by the disclosure has the following characteristics: high hydrophobicity, long-term stability, contact angle greater than or equal to 160±5°, oleophobic property, rolling angle less than or equal to 5°, chemical erosion medium resistance and corrosion resistance, chemical inertia and low surface tension. The coating can be used on surfaces of aluminum and other metal alloys, ceramics, fabrics, glass and other substrates, and physical and chemical parameters of the substrate surface can be improved without any surface pretreatment.

### BRIEF DESCRIPTION OF DRAWINGS

FIG. 1 illustrates a wettability angle diagram of a superhydrophobic multifunctional coating MR-D13A.

FIG. 2 illustrates a wettability angle diagram of a superhydrophobic multifunctional coating MR-D13S.

FIG. 3 illustrates a wettability angle diagram of a superhydrophobic multifunctional coating MR-D13C.

FIG. 4 illustrates a wettability angle diagram of a superhydrophobic multifunctional coating MR-D13D.

FIG. 5 illustrates a wettability angle diagram of a superhydrophobic multifunctional coating MR-D13F®.

FIG. 6 illustrates a wettability angle diagram of a superhydrophobic multifunctional coating MR-D13W.

FIG. 7 illustrates a wettability angle diagram of a superhydrophobic multifunctional coating MR-D13B.

FIG. 8 illustrates changes of wettability angles of the superhydrophobic multifunctional coatings MR-D13A, MR-D13S, MR-D13C, MR-D13D, MR-D13F®, MR-D13W and MR-D13B on aluminum substrates with time.

FIG. 9 illustrates changes of rolling angles of the superhydrophobic multifunctional coatings MR-D13A, MR-D13S, MR-D13C, MR-D13D, MR-D13FR, MR-D13W and MR-D13B on the aluminum substrates with time.

### DETAILED DESCRIPTION OF EMBODIMENTS

In the following, the technical solutions in the embodiments of the disclosure will be clearly and completely described in conjunction with the accompanying drawings. Apparently, the described embodiments are only some of the embodiments of the disclosure, not all of the embodiments. Based on the embodiments in the disclosure, all other embodiments obtained by those skilled in the related art without creative labor belong to the scope of protection of the disclosure.

Unless otherwise specified, the technical means used in the embodiments are conventional means well known to those skilled in the related art.

The disclosure discloses a superhydrophobic multifunctional coating, which includes the following components in percentage by volume: 0.1-3.0% of hydrophobic composition, 1.5-12% of texture stabilizer, 17-60% of binder and 25-80% of alcohol-free substrate material.

Specifically, the hydrophobic composition includes fluorocarbon silane with a molecular formula of CₓH_{y}F13O₃Si, where x is an integer in a range of 10-15, y is an integer in a range of 12-20, and a volume fraction is in a range of 0.5-2.0 v/v %. The hydrophobic composition further includes polymethylsiloxane with a viscosity of 200-1000 cst. In a specific embodiment, the viscosity of the polymethylsiloxane is 200 cst, and a volume fraction of the polymethylsiloxane is in a range of 0.1-1.0 v/v %.

The texture stabilizer is silicon dioxide (fumed), a specific surface area of the silicon dioxide is in a range of 70-320 m²/g, and an average particle size is less than or equal to 5 nm. Considering that the density of silicon dioxide is 0.05 grams per milliliter (g/mL), the volume fraction of 1.5-12 v/v % is converted into mass fraction.

The binder is polysiloxane. Mass fraction of silicon dioxide is in a range of 25-50 wt %, and a mass fraction of tetraethoxysilane is in a range of 10-70 wt %, which are parts of polysiloxane. Polysiloxane is used mainly in the form of ethyl silicate with a weight fraction of silicon dioxide is 28% and 40%.

The alcohol-free substrate material is polymethylcyclosiloxane, and the polymethylcyclosiloxane is Dx, and x is an integer in a range of 4-5.

The preparation process of the superhydrophobic multifunctional coating is as follows: the hydrophobic composition, the texture stabilizer, the binder and the alcohol-free substrate material are sequentially added into a container and stirred uniformly, and a magnetic stirrer with a rotational speed of 700-1200 revolutions per minute (rpm) is used for stirring in order to promote the mixing of the components. A synthesis process is carried out at room temperature, and a superhydrophobic coating solution is synthesized in one step.

When the coating solution is used, a surface of a material to be treated does not need additional pretreatment and can be used directly. The material to be treated can be glass, ceramics, fabrics, aluminum and metal alloys. The coating process of the synthesized coating solution with superhydrophobic function can be completed by pneumatic, hydraulic, spraying and dip coating. On the surface of any type of material to be treated, the surface can be completely coated without defects.

When the material to be treated is soaked in the superhydrophobic coating solution, the material can be soaked in the coating solution for up to 36 hours. If the surface treatment is repeated, a multi-layer coating can be formed, thus improving the physical and chemical parameters of the material, such as increased dielectric properties, high hydrophobicity and stability, high contact angle greater than or equal to 160±5°, high oleophobic property, rolling angle less than or equal to 5°, self-cleaning process, corrosion resistance, chemical inertia, low surface tension and other properties. The drying process of the treated surface can be dried naturally at room temperature or at elevated temperature. When the treated surface is naturally dried at room temperature, it is placed at room temperature for 0.5-48 hours according to the size of the treated surface. When artificial accelerated drying (i.e., drying at elevated temperature) is carried out, the temperature can be 17-100° C., an air flow rate is 10-40 L/s, and the time is 0.005-0.5 hours, the coating can completely cover the material to be treated. The wettability angle parameter of the multifunctional superhydrophobic dielectric coating is tested after it is completely formed. After that, it is placed at room temperature for 168/336/504 hours, and the wettability angle, coating stability and rolling angle are measured repeatedly.

The disclosure will be further described with specific embodiments.

### Embodiment 1 Preparation of MR-D13A Superhydrophobic Coating

The disclosure relates to a preparation method of a superhydrophobic multifunctional coating. The selected substrate can be directly coated without surface pretreatment, and each material is accurately weighed according to the formula: 1v/v % polymethylsiloxane (viscosity is 200 cst) and 0.5 v/v % fluorocarbon silane (molecular formula is C₁₁H₁₃F₁₃O₃Si); 12v/v % silicon dioxide (average particle size is greater than or equal to 5 nm, density is 0.05 g/mL); 20 v/v % polysiloxane; and 66.5 v/v % decamethylcyclopentasiloxane D5. The above materials are added into a beaker in turn, stirred and mixed uniformly by magnetic force at 1000 rpm at room temperature, and a superhydrophobic coating solution is synthesized in one step.

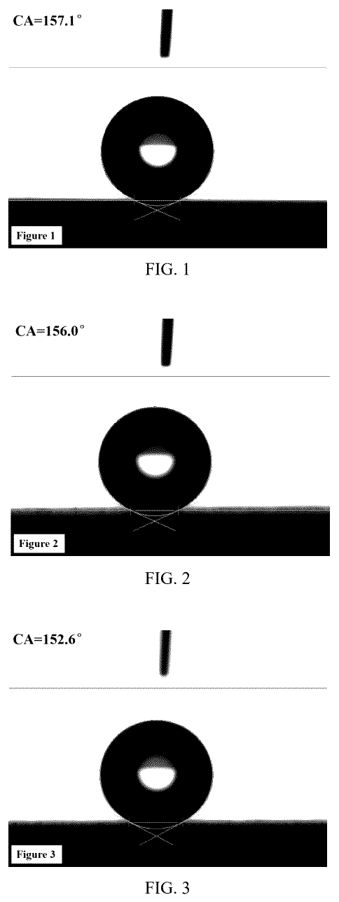

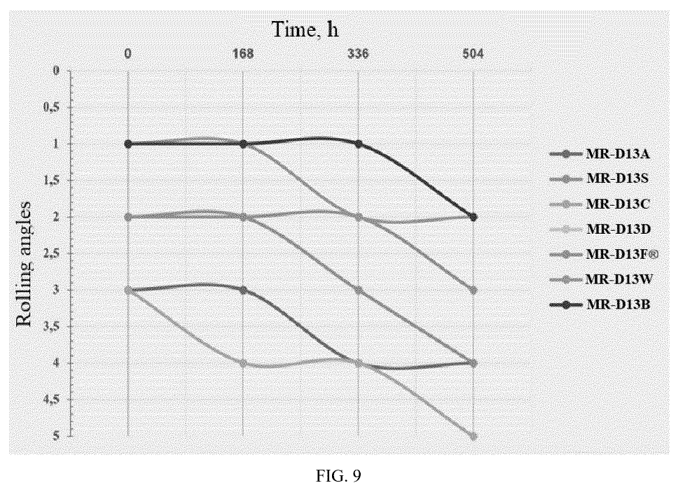

A surface to be treated does not need additional treatment, and the substrate can be glass, fiber fabric or aluminum alloy. The substrate is immersed in the coating solution to soak for 4 hours. Then, the soaked substrate is taken out, which can be naturally dried at room temperature or artificially accelerated. The drying temperature is controlled to 25° C., air flow rate is controlled at 40 L/s, and drying time is controlled to 18 seconds. In this situation, the superhydrophobic multifunctional coating is obtained, and the surface of the substrate is completely covered by the coating. The wettability angle of the coating is tested after drying. The substrate completely covered by the coating is exposed at room temperature for 168 hours, 336 hours and 504 hours respectively, and the wettability angle, rolling angle and stability of the coating are analyzed. The wettability angle is shown in FIG. 1, the change of wettability angle of coating on aluminum substrate with time is shown in FIG. 8, and the change of rolling angle of coating on aluminum substrate with time is shown in FIG. 9.

### Embodiment 2 Preparation of MR-D13S Superhydrophobic Coating

The disclosure relates to a preparation method of a superhydrophobic multifunctional coating. The selected substrate can be directly coated without surface pretreatment, and each material is accurately weighed according to the formula: 0.8 v/v % polymethylsiloxane (viscosity is 300 cst) and 0.75 v/v % fluorocarbon silane (molecular formula is C₁₁H₁₃F₁₃O₃Si); 9.7 v/v % silicon dioxide (average particle size is greater than or equal to 5 nm, density is 0.05 g/mL); 30 v/v % polysiloxane; 58.75 v/v % decamethylcyclotetrasiloxane D4. The above materials are added into a beaker in turn, stirred and mixed uniformly by magnetic force at 900 rpm at room temperature, and a superhydrophobic coating solution is synthesized in one step.

A surface to be treated does not need additional treatment, and the substrate can be glass, fiber fabric or aluminum alloy. The substrate is immersed in the coating solution to soak for 4 hours. Then, the soaked substrate is taken out, which can be naturally dried at room temperature or artificially accelerated. The drying temperature is controlled to 25° C., air flow rate is controlled at 40 L/s, and drying time is controlled to 18 seconds. In this situation, the superhydrophobic multifunctional coating is obtained, and the surface of the substrate is completely covered by the coating. The wettability angle of the coating is tested after drying. The substrate completely covered by the coating is exposed at room temperature for 168 hours, 336 hours and 504 hours respectively, and the wettability angle, rolling angle and stability of the coating are analyzed. The wettability angle is shown in FIG. 2, the change of wettability angle of coating on aluminum substrate with time is shown in FIG. 8, and the change of rolling angle of coating on aluminum substrate with time is shown in FIG. 9.

### Embodiment 3 Preparation of MR-D13C Superhydrophobic Coating

The disclosure relates to a preparation method of a superhydrophobic multifunctional coating. The selected substrate can be directly coated without surface pretreatment, and each material is accurately weighed according to the formula: 0.6 v/v % polymethylsiloxane (viscosity is 300 cst) and 1v/v % fluorocarbon silane (molecular formula is C₁₁H₁₃F₁₃O₃Si); 8.2 v/v % silicon dioxide (average particle size is greater than or equal to 5 nm, density is 0.05 g/mL); 40 v/v % polysiloxane; 50.2 v/v % decamethylcyclotetrasiloxane D4. The above materials are added into a beaker in turn, stirred and mixed uniformly by magnetic force at 900 rpm at room temperature, and a superhydrophobic coating solution is synthesized in one step.

A surface to be treated does not need additional treatment, and the substrate can be glass, fiber fabric or aluminum alloy. The substrate is immersed in the coating solution to soak for 4 hours. Then, the soaked substrate is taken out, which can be naturally dried at room temperature or artificially accelerated. The drying temperature is controlled to 25° C., air flow rate is controlled at 40 L/s, and drying time is controlled to 18 seconds. In this situation, the superhydrophobic multifunctional coating is obtained, and the surface of the substrate is completely covered by the coating. The wettability angle of the coating is tested after drying. The substrate completely covered by the coating is exposed at room temperature for 168 hours, 336 hours and 504 hours respectively, and the wettability angle, rolling angle and stability of the coating are analyzed. The wettability angle is shown in FIG. 3, the change of wettability angle of coating on aluminum substrate with time is shown in FIG. 8, and the change of rolling angle of coating on aluminum substrate with time is shown in FIG. 9.

### Embodiment 4 Preparation of MR-D13D Superhydrophobic Coating

The disclosure relates to a preparation method of a superhydrophobic multifunctional coating. The selected substrate can be directly coated without surface pretreatment, and each material is accurately weighed according to the formula: 0.6 v/v % polymethylsiloxane (viscosity is 200 cst) and 1.25 v/v % fluorocarbon silane (molecular formula is C₁₁H₁₃F₁₃O₃Si); 6.75 v/v % silicon dioxide (average particle size is greater than or equal to 5 nm, density is 0.05 g/mL); 50 v/v % polysiloxane; 41.4 v/v % decamethylcyclopentasiloxane D5. The above materials are added into a beaker in turn, stirred and mixed uniformly by magnetic force at 950 rpm at room temperature, and a superhydrophobic coating solution is synthesized in one step.

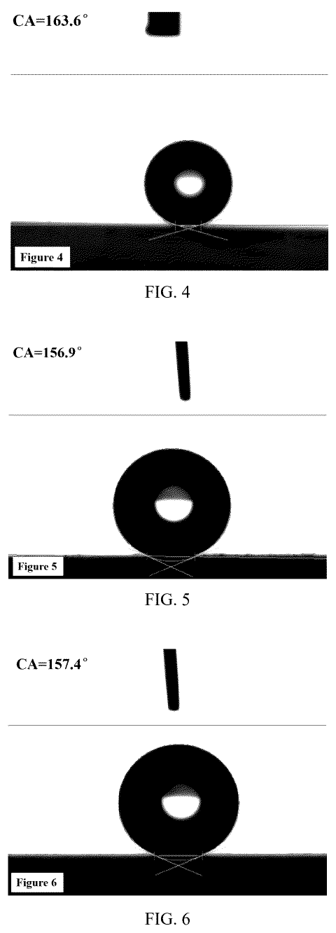

A surface to be treated does not need additional treatment, and the substrate can be glass, fiber fabric or aluminum alloy. The substrate is immersed in the coating solution to soak for 2 hours. Then, the soaked substrate is taken out, which can be naturally dried at room temperature or artificially accelerated. The drying temperature is controlled to 25° C., air flow rate is controlled at 40 L/s, and drying time is controlled to 18 seconds. In this situation, the superhydrophobic multifunctional coating is obtained, and the surface of the substrate is completely covered by the coating. The wettability angle of the coating is tested after drying. The substrate completely covered by the coating is exposed at room temperature for 168 hours, 336 hours and 504 hours respectively, and the wettability angle, rolling angle and stability of the coating are analyzed. The wettability angle is shown in FIG. 4, the change of wettability angle of coating on aluminum substrate with time is shown in FIG. 8, and the change of rolling angle of coating on aluminum substrate with time is shown in FIG. 9.

### Embodiment 5 Preparation of MR-D13F® Superhydrophobic Coating

The disclosure relates to a preparation method of a superhydrophobic multifunctional coating. The selected substrate can be directly coated without surface pretreatment, and each material is accurately weighed according to the formula: 0.4 v/v % polymethylsiloxane (viscosity is 300 cst) and 1.5 v/v % fluorocarbon silane (molecular formula is C₁₁H₁₃F₁₃O₃Si); 5.2 v/v % silicon dioxide (average particle size is greater than or equal to 5 nm, density is 0.05 g/mL); 60 v/v % polysiloxane; 32.9 v/v % decamethylcyclotetrasiloxane D4. The above materials are added into a beaker in turn, stirred and mixed uniformly by magnetic force at 800 rpm at room temperature, and a superhydrophobic coating solution is synthesized in one step.

A surface to be treated does not need additional treatment, and the substrate can be glass, fiber fabric or aluminum alloy. The substrate is immersed in the coating solution to soak for 2 hours. Then, the soaked substrate is taken out, which can be naturally dried at room temperature or artificially accelerated. The drying temperature is controlled to 50° C., air flow rate is controlled at 20 L/s, and drying time is controlled to 0.015 hours. In this situation, the superhydrophobic multifunctional coating is obtained, and the surface of the substrate is completely covered by the coating. The wettability angle of the coating is tested after drying. The substrate completely covered by the coating is exposed at room temperature for 168 hours, 336 hours and 504 hours respectively, and the wettability angle, rolling angle and stability of the coating are analyzed. The wettability angle is shown in FIG. 5, the change of wettability angle of coating on aluminum substrate with time is shown in FIG. 8, and the change of rolling angle of coating on aluminum substrate with time is shown in FIG. 9.

### Embodiment 6 Preparation of MR-D13W Superhydrophobic Coating

The disclosure relates to a preparation method of a multifunctional superhydrophobic coating on a surface of a target material. The selected substrate can be directly coated without surface pretreatment, and each material is accurately weighed according to the formula: 0.2 v/v % of polymethylsiloxane (viscosity is 200 cst) and 1.75 v/v % of fluorocarbon silane (molecular formula is C₁₁H₁₃F₁₃O₃Si); 3.5 v/v % silicon dioxide (average particle size is greater than or equal to 5 nm, density is 0.05 g/mL); 60 v/v % polysiloxane; 34.55 v/v % decamethylcyclopentasiloxane D5. The above materials are added into a beaker in turn, stirred and mixed uniformly by magnetic force at 900 rpm at room temperature, and a superhydrophobic coating solution is synthesized in one step.

A surface to be treated does not need additional treatment, and the substrate can be glass, fiber fabric or aluminum alloy. The substrate is immersed in the coating solution to soak for 2 hours. Then, the soaked substrate is taken out, which can be naturally dried at room temperature or artificially accelerated. The drying temperature is controlled to 50° C., air flow rate is controlled at 20 L/s, and drying time is controlled to 0.015 hours. In this situation, the superhydrophobic multifunctional coating is obtained, and the surface of the substrate is completely covered by the coating. The wettability angle of the coating is tested after drying. The substrate completely covered by the coating is exposed at room temperature for 168 hours, 336 hours and 504 hours respectively, and the wettability angle, rolling angle and stability of the coating are analyzed. The wettability angle is shown in FIG. 6, the change of wettability angle of coating on aluminum substrate with time is shown in FIG. 8, and the change of rolling angle of coating on aluminum substrate with time is shown in FIG. 9.

### Embodiment 7 Preparation of MR-D13B Superhydrophobic Coating

The disclosure relates to a preparation method of a multifunctional superhydrophobic coating on a surface of a target material. The selected substrate can be directly coated without surface pretreatment, and each material is accurately weighed according to the formula: 0.1 v/v % polymethylsiloxane (viscosity is 300 cst) and 2 v/v % fluorocarbon silane (molecular formula is C₁₁H₁₃F₁₃O₃Si); 1.5 v/v % silicon dioxide (average particle size is greater than or equal to 5 nm, density is 0.05 g/mL); 60 v/v % polysiloxane; 36.4 v/v % decamethylcyclopentasiloxane D5. The above materials are added into a beaker in turn, stirred and mixed uniformly by magnetic force at 1100 rpm at room temperature, and a superhydrophobic coating solution is synthesized in one step.

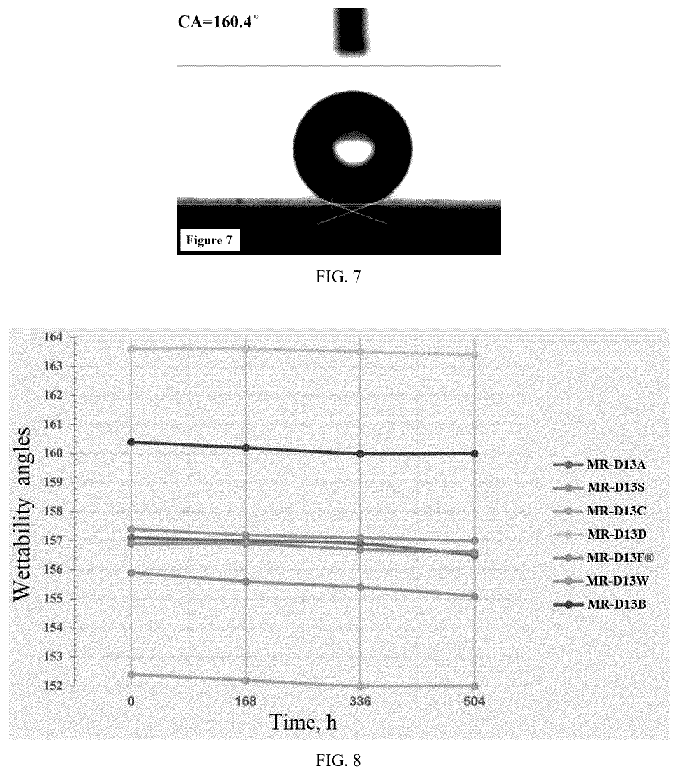

A surface to be treated does not need additional treatment, and the substrate can be glass, fiber fabric or aluminum alloy. The substrate is immersed in the coating solution to soak for 1 hour. Then, the soaked substrate is taken out, which can be naturally dried at room temperature or artificially accelerated. The drying temperature is controlled to 25° C., air flow rate is controlled at 40 L/s, and drying time is controlled to 0.005 hours. In this situation, the superhydrophobic multifunctional coating is obtained, and the surface of the substrate is completely covered by the coating. The wettability angle is shown in FIG. 7, the change of wettability angle of coating on aluminum substrate with time is shown in FIG. 8, and the change of rolling angle of coating on aluminum substrate with time is shown in FIG. 9.

The above-mentioned embodiments only describe the illustrated mode of the disclosure, and do not limit the scope of the disclosure. Under the premise of not departing from the design spirit of the disclosure, various modifications and improvements made by those skilled in the related art to the technical scheme of the disclosure shall fall within the protection scope determined by the claims of the disclosure.

What is claimed is:

1. A superhydrophobic multifunctional coating, comprising the following components in percentage by volume: 0.1-3.0% of hydrophobic composition, 1.5-12% of texture stabilizer, 17-60% of binder, and 25-80% of alcohol-free substrate material.

2. The superhydrophobic multifunctional coating as claimed in claim 1, wherein the hydrophobic composition comprises fluorocarbon silane with a molecular formula of CₓH_{y}F₁₃O₃Si, where x is an integer in a range of 10-15 and y is an integer in a range of 12-20.

3. The superhydrophobic multifunctional coating as claimed in claim 2, wherein the hydrophobic composition further comprises polymethylsiloxane with a viscosity in a range of 200-1000 centistokes (cst).

4. The superhydrophobic multifunctional coating as claimed in claim 1, wherein the texture stabilizer is silicon dioxide, a specific surface area of the silicon dioxide is in a range of 70-320 square meters per gram (m²/g), and an average particle size is less than or equal to 5 nanometers (nm).

5. The superhydrophobic multifunctional coating as claimed in claim 1, wherein the binder is polysiloxane, where a mass fraction of silicon dioxide is in a range 25-50 weight percent (wt %) and a mass fraction of tetraethoxysilane is in a range of 10-70 wt %.

6. The superhydrophobic multifunctional coating as claimed in claim 1, wherein the alcohol-free substrate material is polymethylcyclosiloxane, and the polymethylcyclosiloxane is Dx, where x is an integer in a range of 4-5.

7. A preparation method of the superhydrophobic multifunctional coating as claimed in claim 1, comprising:
uniformly stirring and mixing the hydrophobic composition, the texture stabilizer, the binder and the alcohol-free substrate material to synthesize a superhydrophobic coating solution.

8. The preparation method as claimed in claim 7, further comprising:
immersing a substrate in the superhydrophobic coating solution to soak the substrate for 1-36 hours to obtain soaked substrate, then taking out the soaked substrate, and purging and drying the soaked substrate at a temperature in a range of 17-100 Celsius degree (° C.) and an air flow rate in a range of 10-40 liters per second (L/s), so as to obtain the multifunctional superhydrophobic coating.
